(19) United States
(12) Patent Application Publication
(10) Pub. No.: US 2013/0125558 A1
(43) Pub. Date: May 23, 2013

(54) PREHEATING A SPARK PLUG

(71) Applicants: Luc Henri Chatenet, Seine Port (FR); Christian Schaeffer, Pringy (FR); David Stifanic, La Rochette (FR)

(72) Inventors: Luc Henri Chatenet, Seine Port (FR); Christian Schaeffer, Pringy (FR); David Stifanic, La Rochette (FR)

(73) Assignee: Snecma, Paris (FR)

(21) Appl. No.: 13/701,850

(22) PCT Filed: May 25, 2011
(86) PCT No.: PCT/FR11/51181

§ 371 Date: Feb. 7, 2013

(30) Foreign Application Priority Data
Jun. 4, 2010 (FR) 1054421

(51) Int. Cl. F02C 7/266

(52) U.S. Cl. CPC F02C 7/266
USPC 60/776; 60/39.827

(57) ABSTRACT

A method of igniting a turbine engine using a spark plug including a first electrode, a second electrode, and a semiconductor body between the first electrode and the second electrode, the semiconductor body having an exposed surface, the ignition method including: generating a spark adjacent to the exposed surface by applying a voltage difference greater than a first predetermined threshold between the first electrode and the second electrode; and prior to generating a spark, a preheating applying a voltage difference less than a second predetermined threshold between the first electrode and the second electrode, the second predetermined threshold being less than the first predetermined threshold.

### BACKGROUND OF THE INVENTION

The invention relates to spark plugs for turbine engines. In particular, the present invention relates to the reliability of spark plugs that have semiconductor bodies between their electrodes. Such plugs are, among others, plugs for igniting combustion chambers of turbine engines.

One type of known spark plug has a first electrode and a second electrode separated by a semiconductor body. This type of spark plug offers good reliability and also makes it possible to reduce the size of the ignition boxes that power the plugs. The high-voltage semiconductors that are used may be referred to as “cermet” or “pellet” semiconductors, and are made of a ceramic insulator and of grains of a conductive material. By lowering the breakdown voltage, this technology makes it possible to avoid electricity leakage from the harnesses to which the plugs are connected, and to reduce the size of the power supply transformers.

Unfortunately, that type of spark plug suffers from certain drawbacks. In particular, the semiconductors that are used are sensitive to the conditions of the surrounding environment. In particular, under freezing or wet conditions, rapid deterioration of the plugs is observed. For example, a spark plug having a life cycle under normal conditions of greater than 10,000 ignition cycles may be almost destroyed after 1200 cycles in the presence of persistent moisture. In addition, under wet or freezing conditions, it is observed that many of the sparks ordered are not generated by the plug. Such deficiency can delay ignition of the turbine engine and thus accelerate deterioration of the plug because the cycle is lengthened. Finally, under certain conditions, ignition of the turbine engine does not occur.

### OBJECTS AND SUMMARY OF THE INVENTION

An object of the invention is to propose an ignition method that does not suffer from at least some of the drawbacks suffered by the above-mentioned prior art. A particular object of the invention is to avoid rapid deterioration of a spark plug.

To this end, the invention provides a method of igniting a turbine engine using a spark plug comprising a first electrode, a second electrode and a semiconductor body between the first electrode and the second electrode, the semiconductor body having an exposed surface, the ignition method comprising a step of generating a spark adjacent to said exposed surface by applying a voltage difference greater than a first predetermined threshold between the first electrode and the second electrode, said method being characterized by the fact that, prior to said step of generating a spark, it further comprises a preheating step consisting in applying a voltage difference less than a second predetermined threshold between the first electrode and the second electrode, said second predetermined threshold being less than said first predetermined threshold.

Generating a spark involves ionizing the gas adjacent to the exposed surface of the semiconductor body. However, in freezing or wet conditions, ice or water can cover the exposed surface of the semiconductor body and thereby limit the quantity of gas that can be ionized. In the event an attempt is made to generate a spark in this situation, this results in an increase in the breakdown voltage and in a concentration of the discharge at the surface of the semiconductor, thereby leading to rapid erosion of the semiconductor body and to cracks being formed in the semiconductor body, which cracks accelerate degradation of said body.

The preheating step makes it possible to avoid such rapid degradation. Application of a low voltage between the two electrodes does not generate any spark but rather it generates a leakage current that flows through the semiconductor body. The heat generated makes it possible to dry the plug. Thus, after the preheating step, a spark can be generated without ice or water covering the exposed surface of the semiconductor body.

In an implementation, said preheating step has a predetermined duration greater than 5 seconds. For example, the predetermined duration may lie in the range 30 seconds to 10 minutes.

The first predetermined threshold may be greater than 900 volts (V). The second predetermined threshold may be less than 900 V. For example, the second predetermined threshold is less than or equal to 100 V.

In a variant, during the preheating step, the voltage difference applied between the first electrode and the second electrode is constant.

In another variant, during the preheating step, the voltage difference applied between the first electrode and the second electrode is controlled by a current regulator.

The invention also provides a method of starting a turbine engine comprising a step of causing a starter motor to start rotating the turbine engine, and a step of igniting the turbine engine by implementing the above ignition method, wherein the preheating step starts when the speed of rotation of the turbine engine reaches a predetermined threshold.

The invention also provides an ignition system for a turbine engine, which system comprises a spark plug and a power supply device connected to said spark plug, the spark plug comprising a first electrode, a second electrode and a semiconductor body between the first electrode and the second electrode, the semiconductor body having an exposed surface, the power supply device comprising generation means for generating a spark adjacent to said exposed surface, which means are suitable for applying a voltage difference greater than a first predetermined threshold between the first electrode and the second electrode, said ignition system being characterized by the fact that the power supply device further comprises preheating means suitable for applying a voltage difference less than a second predetermined threshold between the first electrode and the second electrode, said second predetermined threshold being less than said first predetermined threshold.

The power supply device may further comprise an input interface for receiving a control signal, and activation means suitable for activating said generation means or said preheating means as a function of the control signal.

### BRIEF DESCRIPTION OF THE DRAWINGS

The invention can be better understood on reading the following description, given merely by way of non-limiting indication and with reference to the accompanying drawings, in which:

FIG. 1 is a diagram of an embodiment of an ignition system of the invention;

FIG. 2 is a section view of a spark plug of the ignition system shown in FIG. 1;

FIG. 3 shows the end of the spark plug of FIG. 2, as covered with ice or with water;

FIG. 4 is a graph that, for a plurality of FIG. 2 plugs tested, shows the current flowing through the plug as a function of the voltage that is applied; and

FIG. 5 is a graph showing a control signal and the voltage difference applied to the electrodes of the FIG. 2 plug, as a function of time.

### DETAILED DESCRIPTION OF AN EMBODIMENT

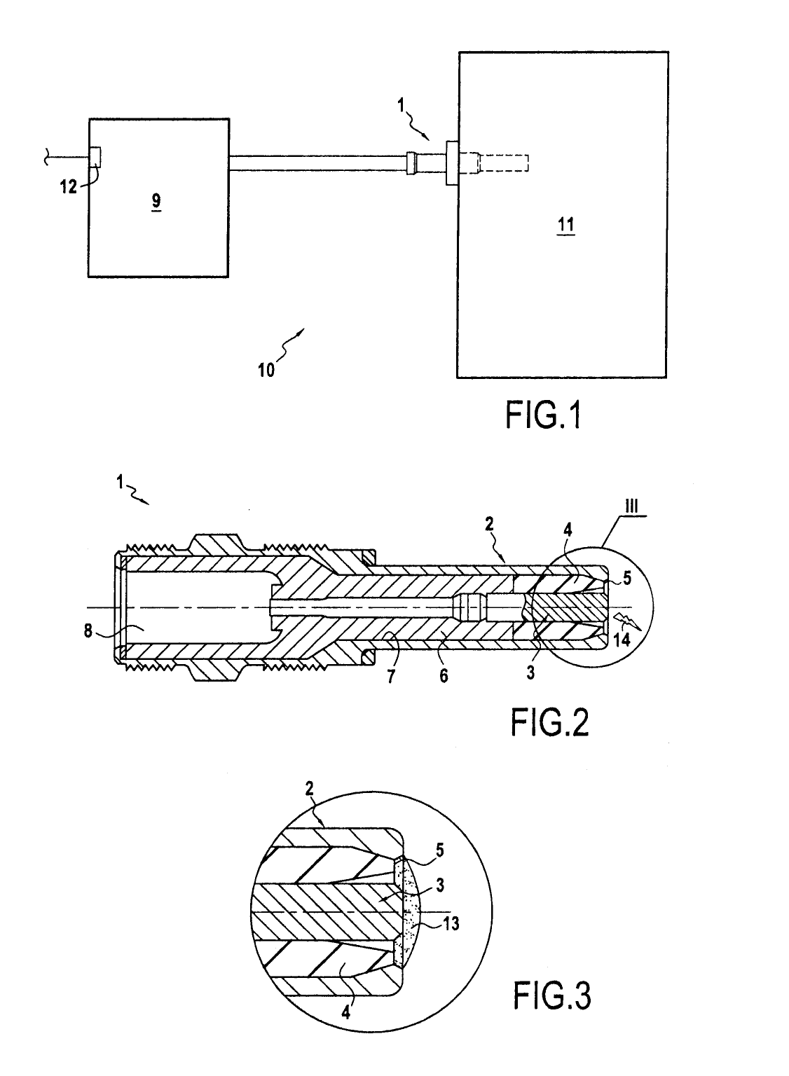

FIG. 1 shows an ignition system 10 for a turbine engine 11. The ignition system 10 generally comprises a plurality of spark plugs designed to generate sparks for igniting the turbine engine 11. The spark plugs are connected to a power supply box 9. The power supply box 9 has an input interface 12 for receiving a control signal. FIG. 1 shows a single spark plug 1.

FIG. 2 is a section view of the spark plug 1. The spark plug 1 has an electrode 2 and an electrode 3.

The electrode 2 has an orifice 7 that is substantially circularly cylindrical, and the electrode 3 is received in the orifice 7. On the right side of FIG. 1, the end of the electrode 3 comes flush with the end of the electrode 2 and a semiconductor body 4 separates the electrodes 2 and 3. The semi-conductor body 4 has an exposed surface 5.

Inside the orifice 7, the electrodes 2 and 3 are separated by insulating material 6. Finally, on the left side of the FIG. 1, the orifice 7 is flared and the end of the electrode 3 is unobstructed, so as to form a connector 8 making it possible to connect the spark plug 1 to the power supply box 9.

Thus, the power supply box 9 can apply a large voltage difference between the electrodes 2 and 3, thereby generating a spark 14 in front of the exposed surface 5 of the semiconductor body 4, as shown in FIG. 2. However, in freezing or wet conditions, a build-up 13 of ice or of water can cover the exposed surface 5 of the semiconductor body 4, as shown in FIG. 3. The build-up 13 can hinder or prevent generation of a spark.

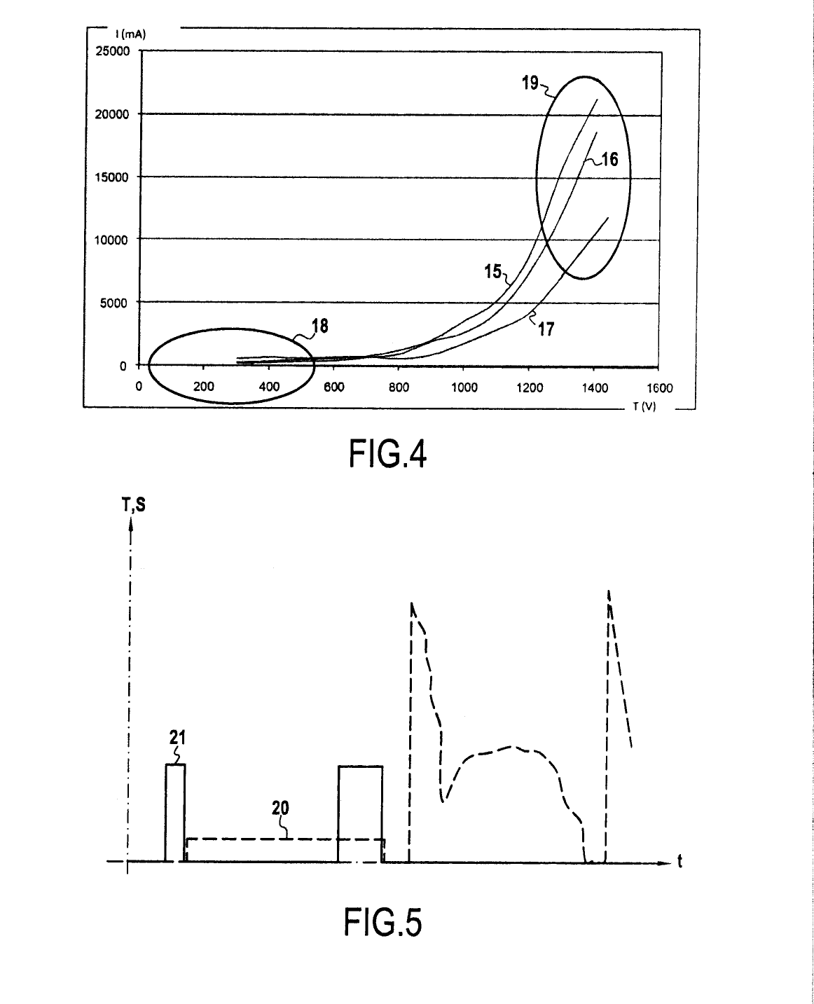

FIG. 4 shows the current I flowing through the spark plug 1 as a function of the voltage difference T applied between the electrodes 2 and 3. The curves 15, 16 and 17 correspond respectively to semiconductor bodies 4 having different compositions.

For a large voltage difference T, typically greater than 900 V, the current I is also high. In the absence of the build-up 13, a spark 14 is generated. The encircled zone 19 corresponds to the zone in which a spark is generated 14.

Conversely, for a small voltage difference T, typically less than 900 V, no spark is generated. However, the spark plug 1 allows a low leakage current I to flow through it, with the value of the current depending on the voltage difference that is applied. FIG. 4 shows that the leakage current is relatively stable in a zone 18.

In order to avoid the problems of deterioration of the spark plug 1 caused by the presence of the build-up 13, the spark plug 1 is preheated before a spark 14 is generated.

More precisely, during a preheating step preceding the step of generating a spark 14, the power supply box 9 applies a small voltage difference between the electrodes 2 and 3, typically approximately in the range 20 V to 100 V. In a variant, a voltage difference of up to 900 V could be applied because no spark is generated. As shown in FIG. 4, a leakage current flows through the semiconductor body 4, which heats up by the Joule effect. The heat generated dries the spark plug 1, thereby removing the build-up 13.

The preheating step is, for example, of duration that is predetermined as a function of the voltage difference applied and of the spark plug 1. Typically, the predetermined duration may lie in the range 30 seconds to 10 minutes.

For example, during tests conducted on a spark plug 1 covered with ice at −15° C., the following drying times were measured:
6 minutes for a voltage difference of 28 V (current of 10 milliamps (mA));
2.5 minutes for a voltage difference of 50 V (current of 20 mA); and
35 seconds for a voltage difference of 100 V (current of 500 mA).

During the preheating step, a voltage difference of constant value is applied. In a variant, the voltage difference may be determined by a current regulator that keeps the current constant.

After the preheating step, the step of generating a spark can take place in conventional manner. More precisely, during a charging stage, the power supply box 9 accumulates energy in a storage element. Then, the stored energy is transferred to the spark plug 1 in order to generate a spark.

The power supply box 9 has an input interface 12 making it possible to receive a control signal. The control signal indicates to the power supply box 9 to switch between a state in which it applies a low voltage for the preheating step and a state in which it applies a high voltage for the step of generating a spark.

For example, the control signal comprises a pulse of short duration for requesting the preheating step and a pulse of longer duration for requesting the step of generating a spark. This example is shown in FIG. 5. In FIG. 5, curve 20 shows the applied voltage difference T as a function of time t, and curve 21 shows the control signal S as a function of time.

In known manner, starting the turbine engine 11 begins with causing the turbine engine 11 to start rotating by means of a starter motor. The speed of rotation of the turbine engine 11 increases progressively. When the speed of rotation reaches a determined level, sparks are generated in order to ignite the turbine engine 11. Given the variation in the speed of rotation of the turbine engine 11 and the predetermined duration for the step of preheating the spark plug 1, it is possible to choose a rotation speed threshold for starting the preheating step.

1-10. (canceled)

11. A method of igniting a turbine engine using a spark plug including a first electrode, a second electrode, and a semiconductor body between the first electrode and the second electrode, the semiconductor body having an exposed surface, the ignition method comprising:
generating a spark adjacent to the exposed surface by applying a voltage difference greater than a first predetermined threshold between the first electrode and the second electrode; and
prior to generating a spark, a preheating including applying a voltage difference less than a second predetermined threshold between the first electrode and the second electrode, the second predetermined threshold being less than the first predetermined threshold.

12. An ignition method according to claim 11, wherein the preheating has a predetermined duration greater than 5 seconds.

13. An ignition method according to claim 11, wherein the first predetermined threshold is greater than 900 V.

14. An ignition method according to claim 11, wherein the second predetermined threshold is less than 900 V.

15. An ignition method according to claim 14, wherein the second predetermined threshold is less than or equal to 100 V.

16. An ignition method according to claim 11, wherein, during the preheating, the voltage difference applied between the first electrode and the second electrode is constant.

17. An ignition method according to claim 11, wherein, during the preheating, the voltage difference applied between the first electrode and the second electrode is controlled by a current regulator.

18. A method of starting a turbine engine comprising:
causing a starter motor to start rotating the turbine engine; and
igniting the turbine engine by implementing the ignition method according to claim 11,
wherein the preheating starts when a speed of rotation of the turbine engine reaches a predetermined threshold.

19. An ignition system for a turbine engine, comprising:
a spark plug and a power supply device connected to the spark plug;
the spark plug comprising a first electrode, a second electrode, and a semiconductor body between the first electrode and the second electrode, the semiconductor body having an exposed surface;
the power supply device comprising generation means for generating a spark adjacent to the exposed surface, which generation means is configured to apply a voltage difference greater than a first predetermined threshold between the first electrode and the second electrode;
wherein the power supply device further comprises preheating means configured to apply a voltage difference less than a second predetermined threshold between the first electrode and the second electrode, the second predetermined threshold being less than the first predetermined threshold.

20. An ignition system according to claim 19, wherein the power supply device further comprises an input interface for receiving a control signal, and activation means configured to activate the generation means or the preheating means as a function of the control signal.
